(19) United States
(12) Patent Application Publication
(10) Pub. No.: US 2013/0099707 A1
(43) Pub. Date: Apr. 25, 2013

(54) BRUSHLESS MOTOR CONTROL METHOD, BRUSHLESS MOTOR CONTROL DEVICE AND ELECTRIC POWER STEERING APPARATUS

(71) Applicant: Masayuki Okubo, Kiryu-shi (JP)

(72) Inventor: Masayuki Okubo, Kiryu-shi (JP)

(21) Appl. No.: 13/617,127

(22) Filed: Sep. 14, 2012

(30) Foreign Application Priority Data
Sep. 27, 2011 (JP) 2011-210064
Jan. 19, 2012 (JP) 2012-8567

(51) Int. Cl. H02P 6/10

(52) U.S. Cl. CPC H02P 6/10
USPC 318/400.23

(57) ABSTRACT

A control device (50) for an IPM-type brushless motor (3) includes a fundamental-current calculating section (52) for calculating fundamental-wave currents indicating winding current values to be set in maximum-torque control, a correction-component calculating section (59) for calculating a first harmonic component (B sin 6(θ+β)) for cancelling a torque ripple for a magnet torque and a second harmonic component (A sin 6(θ+α)) for cancelling a torque ripple for a reluctance torque based on phase-current values detected by a current sensor (64), a correction map (58) storing relationships between the phase currents and parameters (A, B, α, and β) of the first harmonic component and the second harmonic component, and a current-correcting section (60) for superimposing the first harmonic component and the second harmonic component respectively on the fundamental-wave currents to correct a current to be supplied so as to generate current command values (Id′ and Iq′).

### BACKGROUND OF THE INVENTION

1. Field of the Invention

The present invention relates to a technology for reducing a torque ripple in a brushless motor, and more particularly, to a technology which is effective when being applied to a brushless motor to be used as a driving source of an electric power steering apparatus.

2. Related Art Statement

In recent years, the use of a so-called interior permanent magnet (IPM) type motor (hereinafter abbreviated as “IPM motor”) in which a permanent magnet is embedded in a rotor has increased as a driving source for an electric power steering apparatus (hereinafter abbreviated as “EPS”). In the IPM motor, the magnet is embedded in the rotor. Therefore, a difference in inductance between a d-axis (central axis of the permanent magnet) direction and a q-axis (axis electrically and magnetically orthogonal to the d-axis) direction is large. As a result, a reluctance torque Tr is generated in the rotor. Therefore, in the case of the IPM motor, the reluctance torque Tr can be used in addition to a magnet torque Tm generated by the permanent magnet, and hence a total torque Tt of the entire motor can be increased. For the above-mentioned reason, the use of the IPM motor has expanded as a motor with a high efficiency and a high torque not only for the EPS but also for electric automobiles, hybrid automobiles, home electric appliances such as an air conditioner, and various industrial machines.

In the case of the IPM motor, the total torque Tt is expressed as follows. In general, so-called maximum-torque control (lead-angle control) for maximizing a generated torque with respect to the same current is performed.

Tt=Tm+Tr

=p·φa·Iq+p·(Ld−Lq)·Id·Iq

(p: the number of pole pairs, φa: armature flux linkage generated by permanent magnet, Ld: d-axis inductance, Lq: q-axis inductance, Id: d-axis current, Iq: q-axis current)

With the maximum-torque control, an angle β (current phase angle) between Id and Iq is controlled so that a torque is most efficiently generated with respect to an armature current. As a result, an operation with a high efficiency and a high torque is performed.

In the IPM motor, however, when the armature current becomes higher, a proportion of the magnet torque Tm to the reluctance torque Tr in the total torque Tt changes, specifically, Tr tends to increase. In this case, the current value is high. Correspondingly, the effects of an armature reaction become greater. As a result, the torque ripple becomes larger as compared to the case with a low current. In particular, when the reluctance torque exceeds 10%, the torque ripple abruptly increases. As a result, a torque-ripple rate exceeds 5% which is set as an upper limit value for the EPS.

Therefore, various methods have been conventionally proposed to reduce the torque ripple in the IPM motor. For example, a motor control device described in Japanese Patent Application Laid-open No. 2004-64909 obtains the torque ripple by computation so as to compute a current command value for generating a torque having a phase opposite to that of the torque ripple. Then, the current obtained by the computation is supplied to the motor to reduce the torque ripple. In the device described in the above-mentioned publication, the torque ripple due to a fundamental-wave current in a d−q coordinate system and a harmonic component of the armature flux linkage, which is generated by the permanent magnet, is computed by torque-ripple computation means. Next, by a torque-ripple reducing harmonic current command value generator, a harmonic current command value for generating a torque having a phase opposite to that of the torque ripple computed by the torque-ripple computation means is computed. Then, the harmonic current is controlled based on the harmonic current command value in a harmonic current control circuit so as to reduce the torque ripple of the motor.

The device described in Japanese Patent Application Laid-open No. 2004-64909 can indeed reduce the torque ripple. However, a computation load is extremely large. Specifically, after the coordinate conversion of a sinusoidal wave of an induced voltage into the d−q coordinate system, the harmonic current command value for generating the torque having the phase opposite to that of the torque ripple is obtained by the computation. Therefore, a large load is placed on a computing element. In the case of the EPS, in particular, the current is used over a wide range and, in addition, momentarily changes. In order to perform the computation as described above in the above-mentioned device for each time, a CPU having an extremely high throughput is required. Such computation is possible in theory but is difficult in practice.

### SUMMARY OF THE INVENTION

It is an object of the present invention to provide a motor control method and a motor control device, which are capable of reducing a torque ripple of a brushless motor without placing a large computation load on a CPU.

According to the present invention, there is provided a brushless-motor control method for a brushless motor including: a stator including an armature winding having a plurality of phases, which causes an induced voltage between lines to have a sinusoidal waveform; and a rotor into which permanent magnets are embedded, the rotor being provided on an inner side of the stator so as to be rotatable, the brushless motor rotating the rotor by a magnet torque generated due to a magnetic attraction force of the permanent magnets and a reluctance torque generated based on an inductance difference in a magnetic path, the brushless-motor control method including: calculating fundamental-wave currents indicating winding current values, which cause a maximum torque to be output in the brushless motor, in accordance with a load state of the brushless motor; calculating a first harmonic component having an opposite phase with the same amplitude and the same period as an amplitude and a period of a torque ripple for the magnet torque based on a correction map indicating a relationship between phase currents of the armature winding and a parameter used to calculate the first harmonic component; calculating a second harmonic component having an opposite phase with the same amplitude and the same period as an amplitude and a period of a torque ripple for the reluctance torque, which is generated in a state in which the first harmonic component is superimposed, based on the correction map indicating a relationship between the phase currents of the armature winding and a parameter used to calculate the second harmonic component; and superimposing the first harmonic component and the second harmonic component respectively on the fundamental-wave currents to correct a current to be supplied to the armature winding.

According to the present invention, current-correction values, which can diminish the torque ripple for the magnet torque and the torque ripple for the reluctance torque, are set by using a preset correction map while the maximum-torque control is performed. In the correction map, the relationships between the phase-current values and correction parameters are stored. The CPU refers to the correction map based on the detected current value to determine the parameters. In this manner, it is no longer necessary for the CPU to constantly calculate the torque ripple and sequentially compute the command value for diminishing the torque ripple. Thus, in the brushless motor, the load on the CPU at the time of motor control is significantly reduced while the torque ripple is suppressed. As a result, the torque ripple of the brushless motor can be reduced without using a high-performance CPU, and hence system cost can be reduced.

In the above-mentioned brushless-motor control method, the correction map may include: a harmonic coefficient map indicating a relationship between the phase currents of the armature winding and the amplitude of the first harmonic component and a relationship between the phase currents of the armature winding and the amplitude of the second harmonic component; and a phase-adjusting map indicating a relationship between the phase currents of the armature winding and a phase shift between a torque-ripple waveform and the first harmonic component, and a relationship between the phase currents of the armature winding and a phase shift between a torque-ripple waveform and the second harmonic component. Further, as the first harmonic component, there may be set B sin N(θ+β), where B is a harmonic amplitude coefficient, N is a positive integer, θ is a rotational angle in electric angle, and β is a phase shift, to be added to the fundamental-wave current Iqb in a q-axis direction, and as the second harmonic component, there may be set A sin N(θ+α), where A is a harmonic amplitude coefficient, N is a positive integer, θ is a rotational angle in electric angle, and α is a phase shift, to be added to the fundamental-wave current Idb in a d-axis direction. The harmonic coefficient map may store a relationship between the phase currents of the armature winding and the harmonic amplitude coefficient A and a relationship between the phase currents of the armature winding and the harmonic amplitude coefficient B, and the phase-adjusting map may store a relationship between the phase currents of the armature winding and the phase shift α and a relationship between the phase currents of the armature winding and the phase shift β.

Further, the first harmonic component and the second harmonic component may be respectively superimposed on the fundamental-wave currents in a high-load range in which a torque-ripple rate in the brushless motor exceeds 5%. In addition, the brushless motor may be used as a driving source for an electric power steering apparatus.

According to the present invention, there is further provided a brushless-motor control device for a brushless motor including: a stator including an armature winding having a plurality of phases, which causes an induced voltage between lines to have a sinusoidal waveform; and a rotor into which permanent magnets are embedded, the rotor being provided on an inner side of the stator so as to be rotatable, the brushless motor rotating the rotor by a magnet torque generated due to a magnetic attraction force of the permanent magnets and a reluctance torque generated based on an inductance difference in a magnetic path, the brushless-motor control device including: a current sensor for detecting phase currents of the armature winding; a fundamental-current calculating section for calculating fundamental-wave currents indicating winding current values, which cause a maximum torque to be output in the brushless motor, in accordance with a load state of the brushless motor; a correction-component calculating section for calculating a first harmonic component having an opposite phase with the same amplitude and the same period as an amplitude and a period of a torque ripple for the magnet torque, and a second harmonic component having an opposite phase with the same amplitude and the same period as an amplitude and a period of a torque ripple for the reluctance torque, which is generated in a state in which the first harmonic component is superimposed, based on phase-current values detected by the current sensor; a correction map indicating relationships between the phase currents and parameters used to calculate the first harmonic component and the second harmonic component; and a current-correcting section for superimposing the first harmonic component and the second harmonic component, which are calculated by the correction-component calculating section respectively on the fundamental-wave currents to correct a current to be supplied to the armature winding.

According to the present invention, the first harmonic component which can diminish the torque ripple for the magnet torque and the second harmonic component which can diminish the torque ripple for the reluctance torque are calculated by using the preset correction map by the correction-component calculating section, while the fundamental-wave currents at the time of the maximum-torque control are calculated by the fundamental-current calculating section. In the correction map, the relationships between the phase-current values and the correction parameters are stored. The correction-component calculating section refers to the correction map based on the detected current value to determine the parameters so as to calculate the first harmonic component and the second harmonic component. The current-correcting section corrects the fundamental-wave currents based on the first harmonic component and the second harmonic component. As a result, the control device is no longer required to constantly calculate the torque ripple and sequentially compute the command value for diminishing the torque ripple. Thus, in the brushless motor, the load on the CPU at the time of motor control is significantly reduced while the torque ripple is suppressed.

In the above-mentioned brushless-motor control device, the correction map may include: a harmonic coefficient map indicating a relationship between the phase currents of the armature winding and the amplitude of the first harmonic component and a relationship between the phase currents of the armature winding and the amplitude of the second harmonic component; and a phase-adjusting map indicating a relationship between the phase currents of the armature winding and a phase shift between a torque-ripple waveform and the first harmonic component, and a relationship between the phase currents of the armature winding and a phase shift between a torque-ripple waveform and the second harmonic component. Further, the brushless motor may be used as a driving source for an electric power steering apparatus.

On the other hand, according to the present invention, there is further provided an electric power steering apparatus, which uses, as a driving source, a brushless motor including: a stator including an armature winding having a plurality of phases, which causes an induced voltage between lines to have a sinusoidal waveform; and a rotor into which permanent magnets are embedded, the rotor being provided on an inner side of the stator so as to be rotatable, the brushless motor rotating the rotor by a magnet torque generated due to a magnetic attraction force of the permanent magnets and a reluctance torque generated based on an inductance difference in a magnetic path, the electric power steering apparatus being configured to: calculate fundamental-wave currents indicating winding current values, which cause a maximum torque to be output in the brushless motor, in accordance with a load state of the brushless motor; calculate a first harmonic component having an opposite phase with the same amplitude and the same period as an amplitude and a period of a torque ripple for the magnet torque based on a correction map indicating a relationship between phase currents of the armature winding and a parameter used to calculate the first harmonic component; calculate a second harmonic component having an opposite phase with the same amplitude and the same period as an amplitude and a period of a torque ripple for the reluctance torque, which is generated in a state in which the first harmonic component is superimposed, based on the correction map indicating a relationship between the phase currents of the armature winding and a parameter used to calculate the second harmonic component; and superimpose the first harmonic component and the second harmonic component respectively on the fundamental-wave currents to correct a current to be supplied to the armature winding.

According to the present invention, in the electric power steering apparatus, the current-correction values, which can diminish the torque ripple for the magnet torque and the torque ripple for the reluctance torque, are set by using the preset correction map while the maximum-torque control is performed. In the correction map, the relationships between the phase-current values and the correction parameters are stored. The CPU refers to the correction map based on the detected current value to determine the parameters. In this manner, it is no longer necessary for the CPU to constantly calculate the torque ripple and sequentially compute the command value for diminishing the torque ripple. Thus, in the brushless motor, the load on the CPU at the time of motor control is significantly reduced while the torque ripple is suppressed. Moreover, the torque ripple is reduced to a predetermined value or smaller (for example, 5% or smaller) to improve a steering feeling. As a result, the steering feeling can be improved without using a high-performance CPU. Thus, the system cost of the EPS can be reduced.

### BRIEF DESCRIPTION OF THE DRAWINGS

FIG. 1 is an explanatory view illustrating a configuration of an EPS using a brushless motor;

FIG. 2 is a sectional view illustrating a configuration of a brushless motor (6P9S) used in the EPS illustrated in FIG. 1;

FIG. 3 is an explanatory view illustrating a configuration of a stator core;

FIG. 4 is a block diagram illustrating a configuration of a control device in the EPS illustrated in FIG. 1;

FIG. 5 are explanatory graphs showing torque ripples of Tm and Tr;

FIG. 6 are explanatory graphs showing processing for diminishing the torque ripple for Tm;

FIG. 7 are explanatory graphs showing processing for diminishing the torque ripple for Tr;

FIG. 8 is a graph showing relationships between a phase-current value and each of Idb, Iqb, Id′ and Iq′;

FIG. 9 is a graph showing relationships between the phase-current value and each of α and β;

FIG. 10 is a graph showing a relationship between the phase-current value and a torque-ripple rate for each control mode;

FIG. 11 is a sectional view illustrating a configuration of a brushless motor (10P12S) to which the present invention is applied;

FIG. 12 is an explanatory graph showing the torque ripple in the brushless motor (10P12S) illustrated in FIG. 11 in mechanical angle; and

FIG. 13 is an explanatory graph showing the torque ripple in the brushless motor (10P12S) illustrated in FIG. 11 in electric angle.

### DESCRIPTION OF THE PREFERRED EMBODIMENTS

In the following, embodiments of the present invention are described in detail referring to the drawings.

### First Embodiment

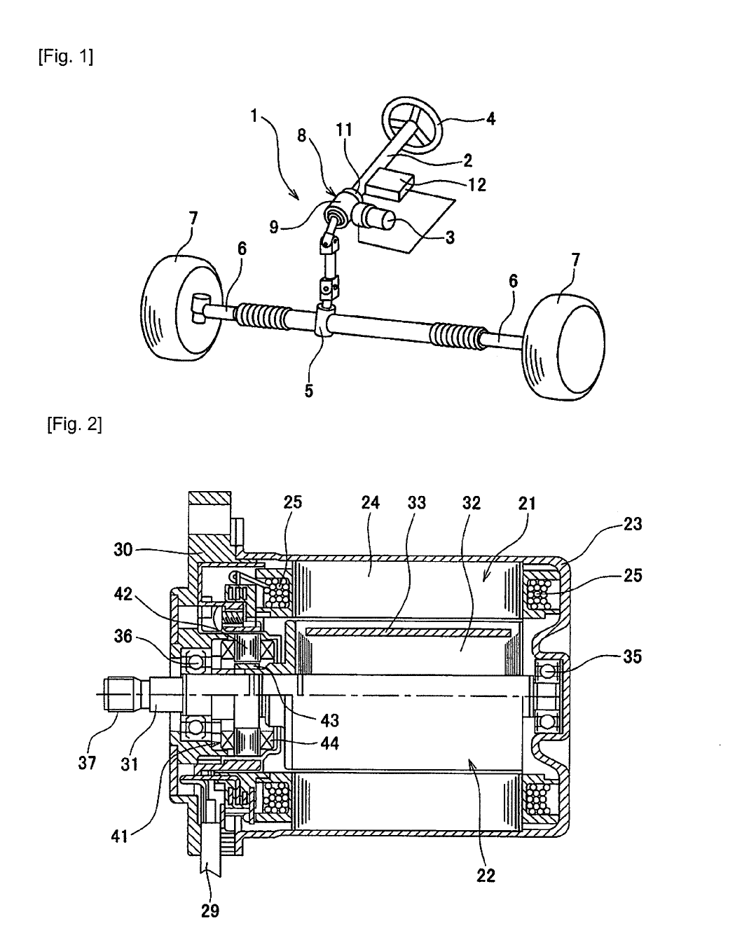

FIG. 1 is an explanatory view illustrating a configuration of an EPS using a brushless motor. Control processing according to the present invention is performed in the EPS illustrated in FIG. 1. An electric power steering apparatus (EPS) 1 illustrated in FIG. 1 is a column-assist type device for applying an operation assist force to a steering shaft 2. In the EPS 1, a brushless motor 3 (hereinafter abbreviated as “motor 3”) is used as a power source.

A steering wheel 4 is mounted to the steering shaft 2. A steering force to the steering wheel 4 is transmitted to a tie rod 6 through a pinion and a rack shaft (both not shown) provided in a steering gear box 5. Wheels 7 are respectively connected to both ends of the tie rod 6. The tie rod 6 is actuated along with an operation of the steering wheel 4 to horizontally steer the wheels 7 through knuckle arms (not shown) or the like.

In the EPS 1, an assist motor section 8, which is a steering-force assist mechanism, is provided to the steering shaft 2. Together with the motor 3, a speed-reduction mechanism section 9 and a torque sensor 11 are provided to the assist motor section 8. A worm and a worm wheel (both not shown) are provided to the speed-reduction mechanism section 9. The rotation of the motor 3 is transmitted to the steering shaft 2 after the rotation is decelerated by the speed-reduction mechanism section 9. The motor 3 and the torque sensor 11 are connected to a control device (ECU) 12.

When the steering wheel 4 is operated to rotate the steering shaft 2, the torque sensor 11 is actuated. The ECU 12 supplies electric power to the motor 3 as appropriate based on a torque detected by the torque sensor 11. When the motor 3 is actuated, the rotation thereof is transmitted to the steering shaft 2 through the speed-reduction mechanism section 9 to apply a steering assist force thereto. The steering shaft 2 is rotated by the steering assist force and a manual steering force. The rotation movement of the steering shaft 2 is converted into linear movement of the rack shaft by rack-and-pinion coupling inside the steering gear box 5 to perform the steering operation of the wheels 7.

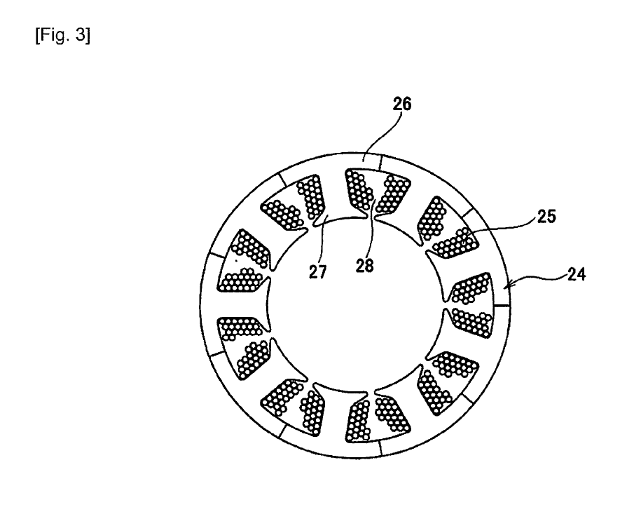

FIG. 2 is a sectional view illustrating a configuration of the motor 3. As illustrated in FIG. 2, the motor 3 is an inner-rotor type brushless motor including a stator 21 provided on the outer side and a rotor 22 provided on the inner side. The stator 21 includes a housing 23, a stator core 24 fixed to an inner circumferential side of the housing 23, and windings 25 wound around the stator core 24. The housing 23 is made of iron or the like to have a cylindrical shape with a closed end. A bracket 30 made of a synthetic resin is mounted to an opening portion of the housing 23. The stator core 24 has a configuration in which a large number of steel plates are laminated. A plurality of teeth are provided on the inner circumferential side of the stator core 24 so as to project therefrom. The stator core 24 is skewed so that a waveform of an induced voltage of the winding 25 becomes a sinusoidal wave. Alternatively, the skew may be formed on the rotor 22 side.

FIG. 3 is an explanatory view illustrating a configuration of the stator core 24. The stator core 24 includes a ring-like yoke portion 26 and teeth 27 formed so as to project from the yoke portion 26 in an inward direction. The number of the provided teeth 27 is nine. Slots 28 (nine in number) are respectively formed between the teeth 27. Therefore, the motor 3 has a 9-slot configuration. A supplemental groove 20 is formed at a distal end of each of the teeth 27. The windings 25 are wound around the respective teeth 27 in concentrated winding. The windings 25 are housed within the respective slots 28. The windings 25 are connected in three phases, that is, U-, V-, and W-phases in star connection. The windings 25 are connected to a battery (not shown) through a feeder line 29. Phase currents (U, V, and W), each containing a harmonic component and having a trapezoidal wave shape, are supplied to the windings 25.

The rotor 22 is provided on the inner side of the stator 21. The rotor 22 has a configuration in which a rotary shaft 31, a rotor core 32, and magnets 33 are arranged coaxially. On an outer circumference of the rotary shaft 31, the rotor core 32 having a cylindrical shape and including a large number of laminated steel plates is mounted. Six slots passing through the rotor core in an axial direction of the rotary shaft 31 are provided to the rotor core 32. The magnets 33 are provided in the respective slots. The motor 3 has an IPM-motor structure. Six magnets 33 are provided along the circumferential direction. The motor 3 has a 6-pole 9-slot (6P9S) configuration.

One end portion of the rotary shaft 31 is rotatably supported by a bearing 35. The other end portion of the rotary shaft 31 is rotatably supported by a bearing 36. The bearing 35 is pressed-fitted into a bottom portion of the housing 23. The bearing 36 is mounted to a bracket 30. A spline portion 37 is formed on the end portion of the rotary shaft 31 (the left end portion in FIG. 2), which is mounted to the bracket 30. The rotary shaft 31 is connected to the worm shaft of the speed-reduction mechanism section 9 by a joint member (not shown). The worm is formed on the worm shaft. The worm is in meshing engagement with the worm wheel in the speed-reduction mechanism section 9. The worm wheel is fixed to the steering shaft 2.

Within the bracket 30, the bearing 36 and a resolver (angle sensor) 41 for detecting a rotational position of the rotor 22 are housed. The resolver 41 includes a resolver stator 42 fixed on the bracket 30 side and a resolver rotor 43 fixed on the rotor 22 side. A coil 44 is wound around the resolver stator 42. An exciting coil and a detection coil are included in the coil 44. On the inner side of the resolver stator 42, the resolver rotor 43 is provided. The resolver rotor 43 has a configuration in which metal plates are laminated. Convex portions are formed in three directions on the resolver rotor 43.

When the rotary shaft 31 rotates, the resolver rotor 43 also rotates inside the resolver stator 42. A high-frequency signal is applied to the exciting coil of the resolver stator 42. By the approach and separation of the convex portions, a phase of the signal output from the detection coil changes. By the comparison between the detected signal and a reference signal, a rotational position of the rotor 22 is detected. Then, based on the rotational position of the rotor 22, the current to the windings 25 is switched as appropriate to rotationally drive the rotor 22.

In the EPS 1 described above, when the steering wheel 4 is operated to rotate the steering shaft 2, the rack shaft moves in a direction in accordance with the rotation to perform the steering operation. By the operation of the steering wheel 4, the torque sensor 11 is actuated. Electric power is supplied from a battery (not shown) to the windings 25 through the feeder line 29 in accordance with the torque detected by the torque sensor 11. When the electric power is supplied to the windings 25, the motor 3 is actuated to rotate the rotary shaft 31 and the worm shaft. The rotation of the worm shaft is transmitted to the steering shaft 2 through the worm wheel to assist the steering force.

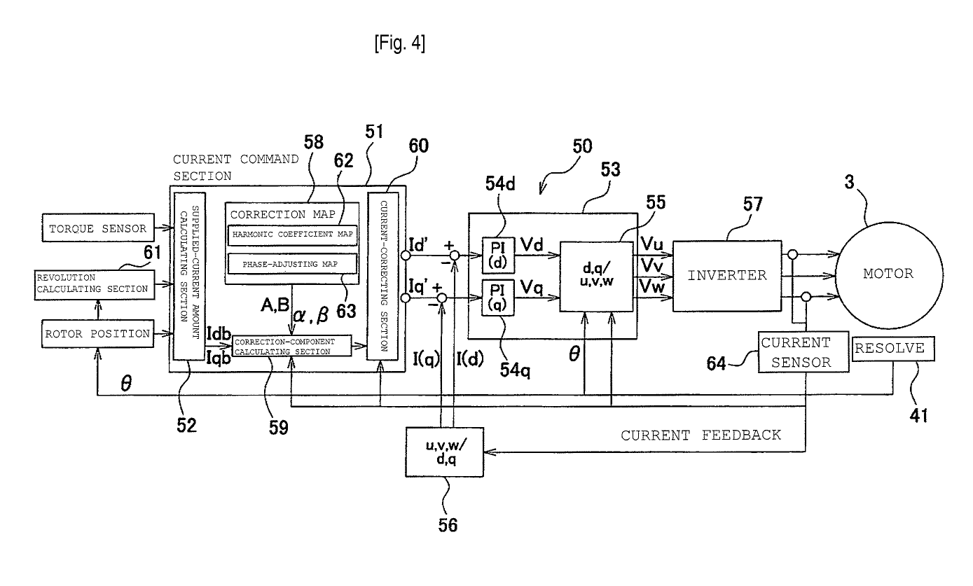

FIG. 4 is a block diagram illustrating a configuration of a control device 50 for the EPS 1. A control method of the present invention is executed in the control device 50. As described above, the driving of the EPS 1 is controlled based on the detected value by the torque sensor 11 and the rotational-position information of the rotor 22, which is detected by the resolver 41. As illustrated in FIG. 4, the resolver 41 is provided to the motor 3 as the angle sensor. The rotational position of the rotor is sequentially input from the resolver 41 to a current command section 51 as rotor rotational-position information. Along with the operation of the steering wheel 4, a torque value which becomes a load on the motor 3 is input as motor load information from the torque sensor 11 to the current command section 51. In a stage prior to the current command section 51, a rotor revolution calculating section 61 is provided. The rotor revolution calculating section 61 calculates the number of revolutions of the rotor 22 based on the rotor rotational-position information. The rotor revolution information is also input to the current command section 51 from the rotor revolution calculating section 61.

The current command section 51 includes a fundamental-current calculating section 52. The fundamental-current calculating section 52 performs computation processing based on the detected values such as the torque value and the rotor revolution to calculate a fundamental-current amount to be supplied to the motor 3. The fundamental-current calculating section 52 calculates the amount of current to be supplied to the motor 3 from the rotor rotational-position information from the resolver 41, the rotor revolution information, and the motor load information. The fundamental-current calculating section 52 calculates fundamental-wave currents Idb and Iqb of Id and Iq, with which a maximum torque can be obtained, as the amount of current to be supplied, for a d-axis (Cartesian-coordinate system component which does not contribute to the torque) and a q-axis (Cartesian-coordinate system component which contributes to the torque).

The current command section 51 also includes a correction map 58 for diminishing a torque ripple of a magnet torque Tm and a torque ripple of a reluctance torque Tr. The two torque ripples generated by the motor current differ for each motor. Therefore, a dedicated correction map 58 is provided for each motor. The correction map 58 stores correction data (a harmonic coefficient map 62 and a phase-adjusting map 63) obtained by individually examining each of the torque ripples of Tm and Tr in advance to correct the fundamental-wave currents Idb and Iqb so as to diminish each of the torque ripples. The correction data of the correction map 58 is acquired in advance by an experiment or analysis. Here, the relationships between the phase-current values of the windings 25 and correction parameters are stored.

The current command section 51 further includes a correction-component calculating section 59 and a current-correcting section 60. The current value of the motor 3, which is detected by the current sensor 64, is fed-back to the correction-component calculating section 59 and the current-correcting section 60. The current-correcting section 60 corrects the fundamental-wave currents Idb and Iqb, which are calculated in advance in the fundamental-wave calculating section 52, by using the correction map 58 to output the corrected currents as current command values Id′ and Iq′ to a vector control section 53. At this time, the correction-component calculating section 59 acquires the correction parameters by using the correction map 58 from the phase-current values detected by the current sensor 64. The current-correcting section 60 superimposes predetermined harmonic components on the fundamental-wave currents Idb and Iqb based on the results of correction to generate the current command values Id′ and Iq′.

The vector control section 53 includes a proportional-integral (PI) control section 54d for the d-axis, a PI control section 54q for the q-axis, and a coordinate-axis converting section (dq/UVW) 55. The current command values Id′ and Iq′ are respectively input to the PI control sections 54d and 54q. Detected-current values I(d) and I(q), which are obtained by d−q axis conversion of the motor current values of the three phases (U, V, W) through a coordinate-axis conversion section (UVW/dq) 56, are respectively input to the PI control sections 54d and 54q. The PI control sections 54d and 54q perform PI computation processing based on the current command values Id′ and Iq′ and the detected current values I(d) and I(q) to calculate voltage command values Vd and Vq for the d-axis and the q-axis, respectively. The voltage command values Vd and Vq are input to the coordinate-axis converting section 55 so as to be converted to voltage command values Vu, Vv, and Vw of the three phases (U, V, W) and are then output. The voltage command values Vu, Vv, and Vw output from the coordinate-axis converting section 55 are applied to the motor 3 through an inverter 57.

Here, a total torque Tt of the motor 3 is, as described above, expressed by:

Tt=Tm+Tr

=p·φa·Iq+p·(Ld−Lq)·Id·Iq

The torque ripples of Tm and Tr are different from each other, while the torque ripples both contain Iq. Therefore, even when Iq for diminishing one of the torque ripples is set, the other torque ripple cannot be diminished. Moreover, Tr also contains Id. Therefore, it is extremely difficult to individually extract Tm and Tr from Tt at the time of driving of the motor to simultaneously reduce the torque ripples so as to diminish the torque ripple of the entire motor at once.

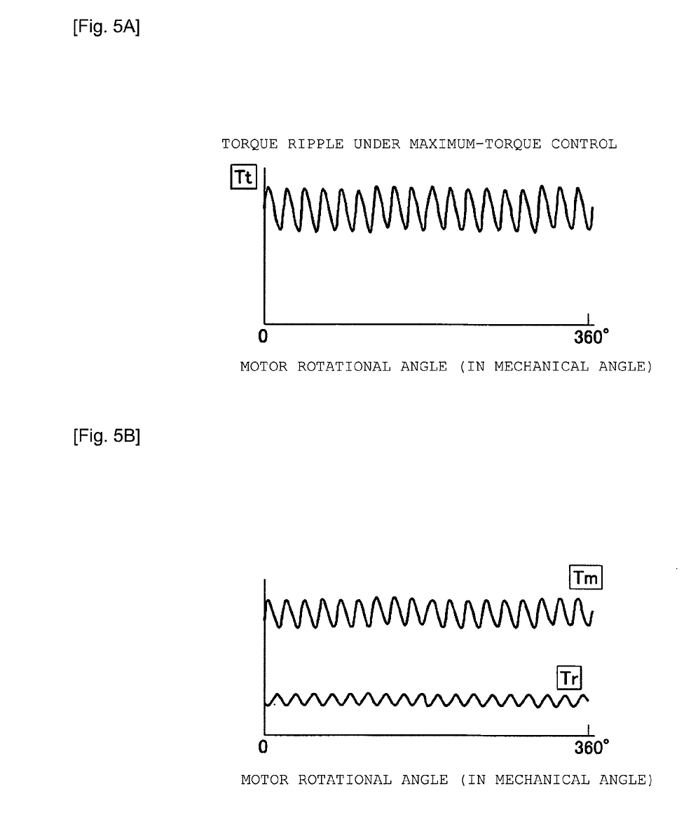

Thus, in the present invention, the torque ripple is considered separately for Tm and Tr from the beginning. The Iq value for diminishing the torque ripple for Tm is first set. Next, in consideration of the corrected Iq value, the Id value for diminishing the torque ripple for Tr is set. At this time, in the control processing of the present invention, the torque ripple is not sequentially computed as in the conventional processing. Instead, the harmonic components having waveforms which cancel out the torque ripples are added based on the correction map in view of the property (waveform) of the torque ripple. On the correction map 58, the relationships between the parameters used to set the harmonic components and the phase-currents are shown. By referring to the correction map 58, the harmonic components to be superimposed are immediately calculated from effective values of the phase currents of the motor 3, which are detected by the current sensor 64. By adding the harmonic components to the fundamental-wave currents, the current command values Id′ and Iq′, which contain a component for cancelling out the torque ripple for Tm and the torque ripple for Tr simultaneously, are set. As a result, the torque ripple of the entire motor is diminished at once. In the following, the control processing described above is specifically described referring to FIGS. 5 to 7.

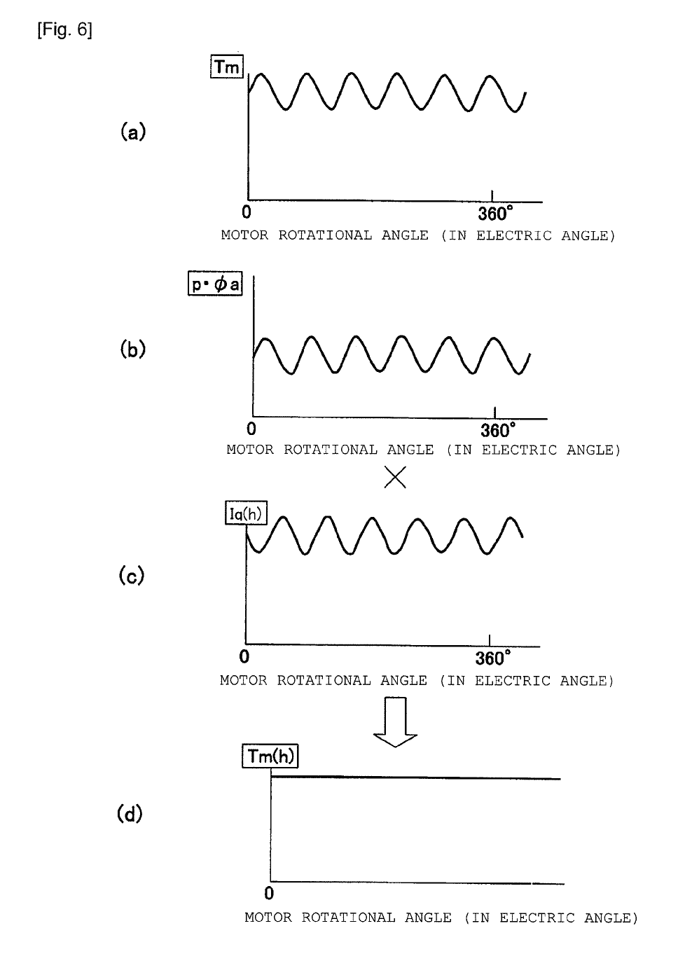

First, as shown in FIG. 5(a), in the 6-pole 9-slot motor as in the case of the motor 3, torque ripples, each having eighteen peaks, are generated respectively for Tm and Tr for one revolution (mechanical angle of 360 degrees) of the rotor. However, the torque ripples of Tm and Tr differ in phase and amplitude (FIG. 5(b)). Therefore, the harmonic component having an opposite phase, which can diminish both the torque ripples simultaneously, cannot be set. Therefore, as described above, the torque ripple is separately considered for Tm and Tr. The ripple of Tm (=p·φa·Iq (Iq: constant)) in the 6-pole 9-slot motor has: 18/3=6th order (six peaks) in electric angle, as shown in FIG. 6(a). The ripple of Tm/Iq=p·φa also has 6th order (six peaks) in electric angle, as shown in FIG. 6(b).

Therefore, by multiplying the ripple by 6n-th (n is a positive integer; n=1 in this case) Iq(h) having the opposite phase as shown in FIG. 6(c), the torque ripple for Tm is cancelled to become 0 (FIG. 6(d)). Specifically, in order to diminish the torque ripple for Tm, a 6th-order harmonic component (first harmonic component) is added to the fundamental wave of Iq to set the current command value Iq′ as expressed by the following expression.

Iq′(θ)=Iqb(fundamental-wave current)+B sin 6(θ+β)

(B: harmonic amplitude coefficient, β: phase shift, θ: rotational angle (in electric angle))

As described above, the torque ripple for Tm is reduced to 0, and Iq at this time is denoted as Iq(h). The total torque Tt(h) at this time becomes equal to the sum of the magnet torque Tm(h) and the reluctance torque Tr(h) with Iq(h), and

Tt(h)=Tm(h)+Tr(h)

=p·φa·Iq(h)+p·(Ld−Lq)·Id·Iq(h)

is obtained. In the expression described above, the torque ripple for Tm in the first term is 0, and therefore is constant. On the other hand, the second term has the torque ripple containing Iq(h). Specifically, when Iq′(θ) described above is used, the torque ripple for Tm becomes 0. However, for some Iq(h), the torque ripple for Tr is not eliminated.

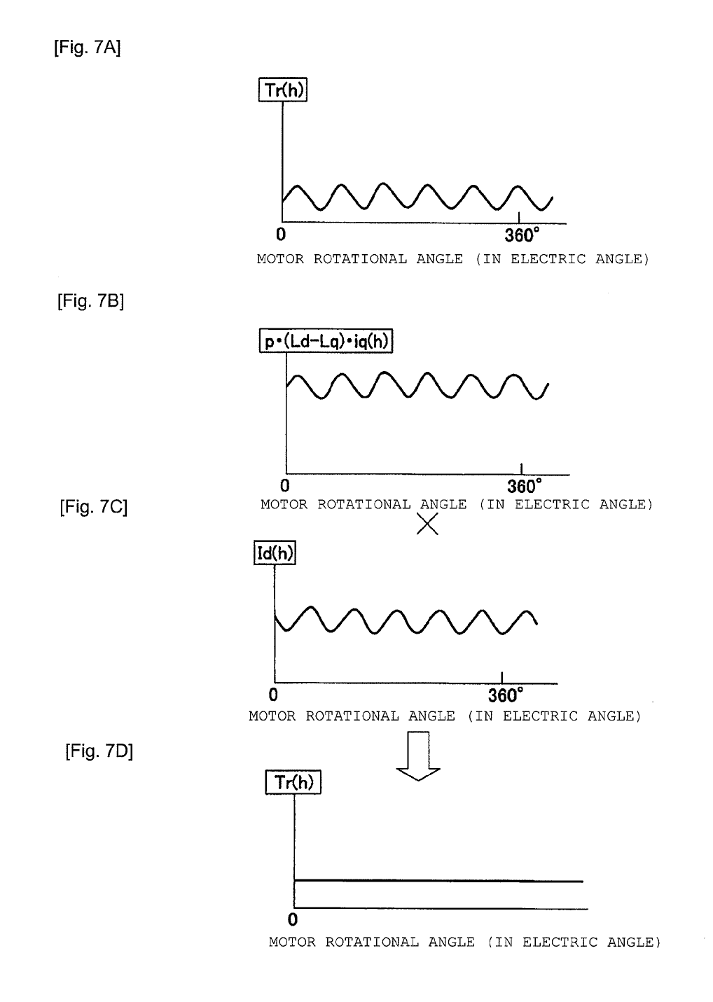

Therefore, Tr(h)=p·(Ld−Lq)·Id·Iq(h) is examined again. Even in this case, the ripple of Tr(h) in the 6-pole 9-slot motor has the 6th order in electric angle as in the above-mentioned case, as shown in FIG. 7(a). On the other hand, when it is considered that Id is constant as in the case of normal maximum-torque control, the ripple of Tr(h)/Id=p·(Ld−Lq)·Iq(h) also has the 6th order (six peaks) in electric angle, as shown in FIG. 7(b). Therefore, when the torque ripple of Tr(h) is multiplied by Id(h) having the opposite phase (6n-th order (n is a positive integer; n=1 in this case)) as shown in FIG. 7(c), the torque ripple of Tr(h) is cancelled to become 0 (FIG. 7(d)). Specifically, in order to diminish the torque ripple for Tr, it is only necessary to add a 6th-order harmonic component (second harmonic component) to the fundamental wave of Id so as to set the current command value Id′ as expressed by the following expression.

Id′(θ)=Idb(fundamental-wave current)+A sin 6(θ+α)

(A: harmonic amplitude coefficient, α: phase shift, θ rotational angle (in electric angle))

The above-mentioned points are summarized as follows. In order to diminish the ripple of the total torque Tt, the ripple for Tm is first set to 0. Thereafter, the condition under which the ripple for Tr can be set to 0 is examined. As a result, it is only necessary to correct the current command values Id′ and Iq′ as expressed by the following expressions.

Id′(θ)=Idb+A sin 6(θ+α) (Expression 1)

Iq′(θ)=Iqb+B sin 6(θ+β) (Expression 2)

The harmonic amplitude coefficients A and B mean amplitudes of the 6th-order harmonic components having the opposite phase, which are added to cancel the torque ripples. The phase shift α means a phase shift between the torque-ripple waveform for Tm and sin θ, whereas the phase shift β means a phase shift between the torque-ripple waveform for Tr and sin θ. In this case, the ripple for Tm and the ripple for Tr have different waveforms. Therefore, the different values α and β are respectively set in Expressions 1 and 2.

Based on the above-mentioned results of examination, in the system of the present invention, Idb and Iqb (fundamental-wave currents) are obtained in the fundamental-current calculating section 52. Thereafter, Idb and Iqb are corrected in the current-correcting section 60 to set the current command values Id′ and Iq′. At this time, the current-correcting section 60 acquires A, B, α, and β from the harmonic coefficient map 62 and the phase-adjusting map 63 based on the detected current value (phase-current value) to calculate the current command values Id′ and Iq′. In the harmonic coefficient map 62, the relationships between the phase-current values and the harmonic amplitude coefficients A and B are stored. In the phase-adjusting map 63, the relationships between the phase-current values and the phase shifts α and β are stored. The current-correcting section 60 calculates the current command values Id′ and Iq′ based on Expressions 1 and 2 while referring to the maps 62 and 63.

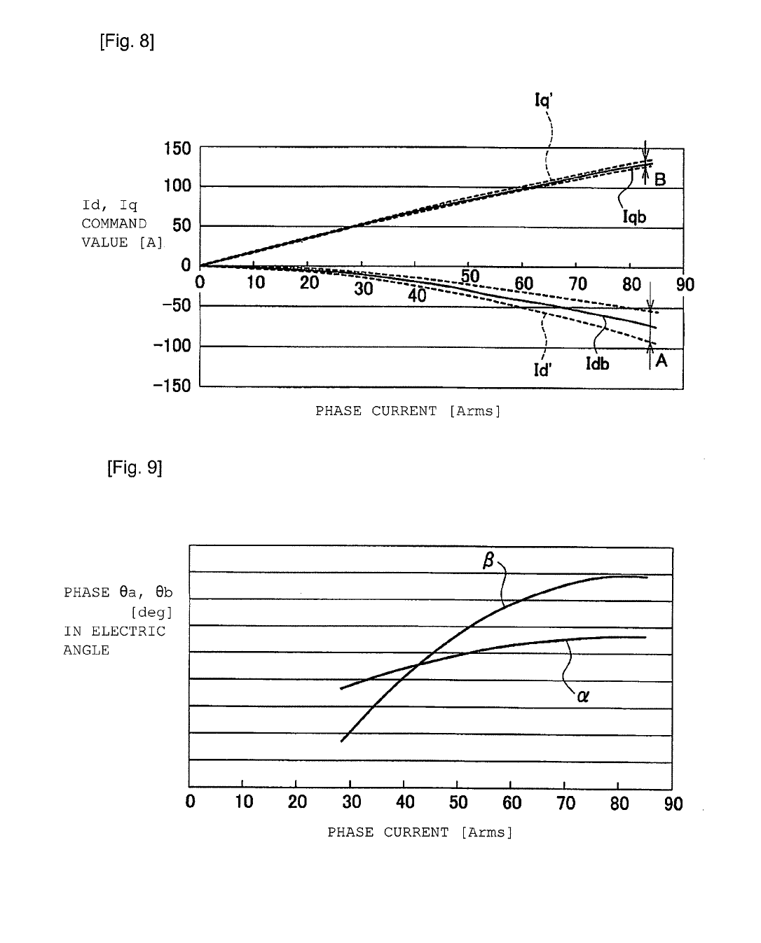

FIG. 8 is a graph showing the relationships between the phase-current value and each of Idb, Iqb, Id′, and Iq′. As shown in FIG. 8, values of Id′ and Iq′ (wave lines) respectively have vertical widths with Idb and Iqb (solid lines) as their centers. The widths correspond to changes in numerical values in the second terms in Expressions 1 and 2, that is, the amplitudes A and B of the harmonic components. The 6th-order harmonic components having the amplitudes A and B are respectively added to Idb and Iqb to set Id′ and Iq′ as indicated by the wave lines in FIG. 8. In the harmonic coefficient map 62, the amplitudes A and B (widths between the wave lines) as described above are stored so as to correspond to the phase-current value. The current-correcting section 60 acquires the harmonic amplitude coefficients A and B in Expressions 1 and 2, respectively, by using the harmonic coefficient map 62 from the phase-current value detected by the current sensor 64.

FIG. 9 is a graph showing the relationships between the phase-current value and each of α and β. As described above, α and β have different values for Tm and Tr and also have different phases depending on the phase-current value. Therefore, it is necessary to take changes in α and β which depend on the phase-current value into consideration. FIG. 9 shows such changes in α and β. In the phase-adjusting map 63, the relationships shown in FIG. 9 are stored. The current-correcting section 60 acquires the phase shifts α and β in Expressions 1 and 2, respectively, by using the phase-adjusting map 63 from the phase-current values detected by the current sensor 64.

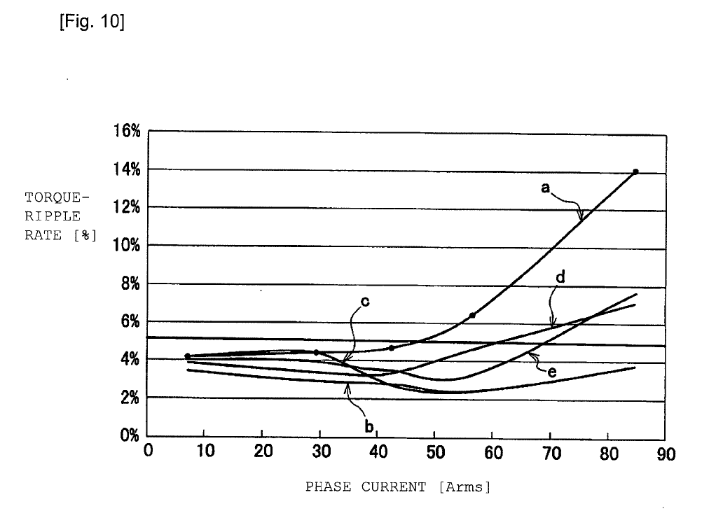

By using the control mode as described above, in the system of the present invention, the torque-ripple rate in a high-load range was successfully reduced to 5% or lower while a CPU comparable to a conventional CPU was used. FIG. 10 is a graph showing the relationship between the phase-current value and the torque-ripple rate for each control mode. As shown in FIG. 10, in the case where conventional maximum-torque control was merely performed (indicated by the arrow a), the torque-ripple rate exceeded 5% in the vicinity of 45 Arms of the phase-current value (effective value). On the other hand, in the case where the control according to the present invention was performed over the entire current range (indicated by the arrow b), the torque-ripple rate was reduced to be 5% or lower even when the phase-current value exceeded 80 Arms. Therefore, in the EPS using the control method and the control device according to the present invention, the torque ripple is not increased even when the load on the motor increases as in the case where stationary steering or the like is performed. As a result, a steering feeling can be improved.

Moreover, in the motor in which the current is used over a wide range as in the case of the motor for the EPS, the revolution becomes extremely high on the low load side. Therefore, when the 6th-order harmonic waves are superimposed over the entire range, there is a possibility that a processing speed of the CPU may not catch up in a high revolution range. Therefore, in view of the control processing at the time of rotation at the high revolution, a control mode in which only maximum-torque control was performed (without adding the 6th-order harmonic components) when the load was low (30 Arms or lower) and the control was switched to the control processing described above when the load exceeded 30 Arms was also carried out (indicated by the arrow c). Even in this case, the torque-ripple rate was successfully reduced to 5% or lower over the entire current range. It was also found that the torque-ripple rate was reduced to 5% or smaller when the harmonic waves were added as needed. In the control mode described above, the load on the CPU in the high revolution range can be reduced to decrease the computation load in the control device. Therefore, the control mode is extremely effective to reduce the control load in the motor for the EPS.

Further, even in the case where the maximum-torque control was performed while the harmonic component was added to only one of Id and Iq (only Id=improvement of the ripple for Tr: indicated by the arrow d, only Iq=improvement of the ripple for Tm: indicated by the arrow e), the improvement of the torque-ripple rate was observed as compared to the case where only the maximum-torque control was performed. However, the torque-ripple rate exceeded 5% for both of Id and Iq in the high-load range where the load was 60 to 70 Arms or higher. Therefore, it has been found that it is preferred to add the harmonic components to both Id and Iq.

As described above, in the control processing according to the present invention, lead-angle control for obtaining the maximum torque is performed. At the same time, the torque ripple is considered separately for Tm and Tr. The current command values Id′ and Iq′ which can diminish the respective torque ripples are set by using the preset correction map. In the correction map, the relationships between the current effective value of each phase and the correction parameters are stored. The control device refers to the correction map by the detected current value to determine the parameter. Specifically, in the present invention, necessary constants are pre-mapped. The CPU can calculate the current command values Id′ and Iq′ only by referring to the constants. As a result, the control device is no longer required to constantly calculate the torque ripple to sequentially compute the command value for diminishing the torque ripple. Accordingly, the load on the CPU in the control of the IPM motor can be remarkably reduced.

### Second Embodiment

Next, as a second embodiment of the present invention, the case where the present invention is applied to a brushless motor having a 10-pole 12-slot (10P12S) configuration is described. In the following embodiment, the same members and portions as those of the first embodiment are denoted by the same reference symbols, and the description thereof is herein omitted.

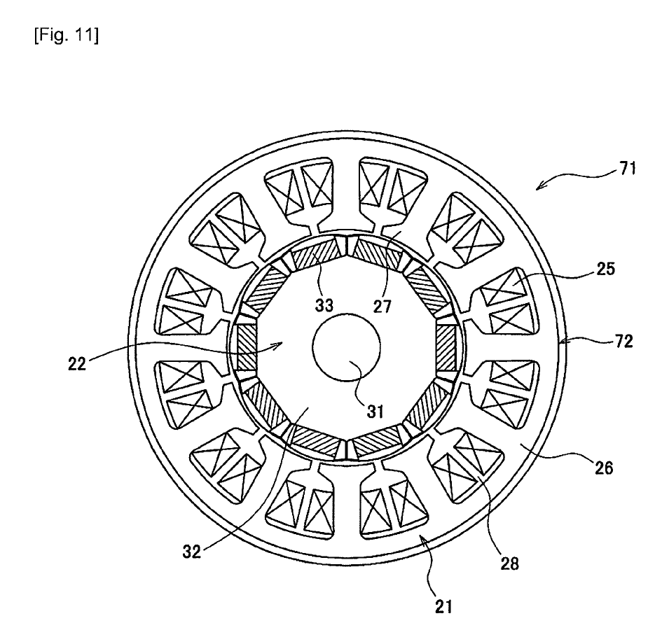

FIG. 11 is an explanatory view illustrating a configuration of a brushless motor 71 (hereinafter abbreviated as “motor 71”). A stator core 72 of the brushless motor 71 similarly includes the ring-shaped yoke portion 26 and the teeth 27 formed so as to project in the inward direction from the yoke portion 26. The number of provided teeth 27 is twelve. The slots 28 (twelve in number) are formed between the teeth 27. On the inner side of the stator core 72, the rotor 22 is provided. Similarly to the motor 3 of the first embodiment, the magnets 33 are embedded in the rotor core 32 (IPM-motor structure). Ten magnets 33 are arranged along the circumferential direction. Therefore, the motor 71 has a 10-pole 12-slot configuration.

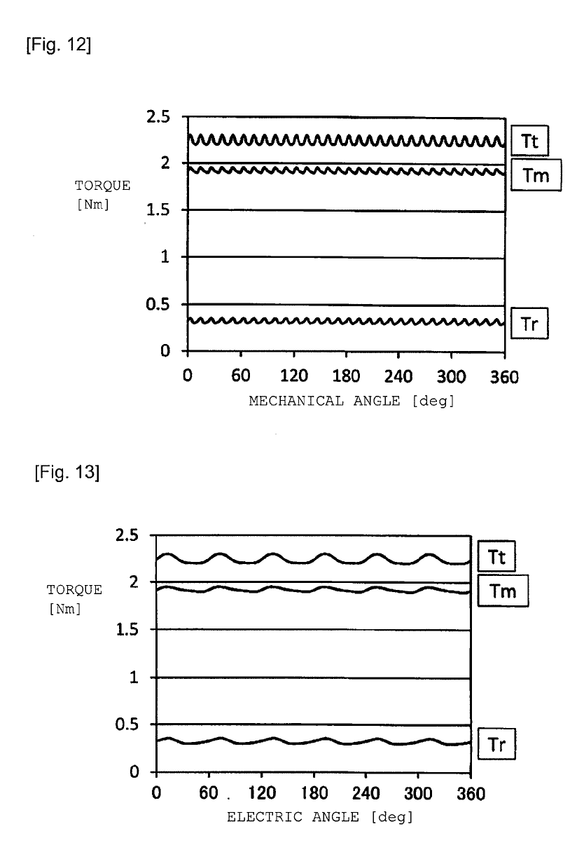

In the motor 71 having the 10-pole 12-slot configuration as described above, the torque ripples are generated in the form as shown in FIG. 12. FIG. 12 is an explanatory graph showing the torque ripples generated in the brushless motor (10P12S) illustrated in FIG. 11 in mechanical angle. On the other hand, the torque ripples shown in FIG. 12 are expressed in electric angle as shown in FIG. 13. The ripples for Tm and Tr have the 6th order (six peaks) as in the case of FIGS. 6 and 7. Therefore, also in the 10S12S motor 71, the ripple of the total torque Tt can be diminished by the same technique as that used in the first embodiment. Specifically, first, by the harmonic component (first harmonic component) having the opposite phase, which has the same amplitude and the same period as those of Tm, the ripple for Tm is reduced to 0. Thereafter, the harmonic component (second harmonic component) having the opposite phase, which has the same amplitude and the same period and is generated in a state in which the first harmonic component is superimposed, is superimposed on the fundamental-wave current. As a result, the ripple for Tr can be reduced to 0 to diminish the ripple of the total torque Tt in the motor 71.

As described above, the technique of the first embodiment of the present invention is applicable not only to the motors having a 2P3S×n configuration such as 6P9S and 8P12S based on the 2P3S configuration but also to motors having 10P12S, 14P12S, and other such configurations, in which a ripple having six peaks is generated over the electric angle of 360 degrees, in completely the same fashion. Specifically, according to the present invention, for each of the motors, in which the ripple waveform expressed in electric angle has the same order as that in the invention of the present application, the torque ripple can be reduced by adding similar harmonic components regardless of the number of poles and the number of slots.

It is apparent that the present invention is not limited to the embodiments described above and various changes are possible without departing from the gist thereof.

For example, in the embodiments described above, the 6n-th order harmonic waves are added to be contained in Id and Iq based on the motor specifications in the embodiments described above. However, the order of the harmonic waves to be added to be contained therein is changed as appropriate depending on the motor specifications. Moreover, even by adding the harmonic wave only to Iq in the case where the proportion of Tm is large and only to Id in the case where the proportion of Tr is large, the effects of reducing the torque ripple can be obtained. Therefore, the 6n-th order harmonic waves are not necessarily required to be added to both Id and Iq.

In the embodiments described above, the example where the IPM motor is used as the brushless motor has been described. However, an applicable motor is not limited thereto. Specifically, the present invention is also applicable to a brushless motor having a structure in which, for example, the magnets are fixed on the outer circumference of the rotor as long as the brushless motor is rotated by the magnet torque generated by a magnetic attraction force of the permanent magnets and the reluctance torque based on the inductance difference in a magnetic path.

Further, in the embodiments described above, the example where the present invention is applied to the EPS has been described. However, an object to which the present invention is applied is not limited to the EPS. The present invention is also applicable to motors used for electric automobiles, hybrid automobiles, home electric appliances such as an air conditioner, various industrial machines, and the like.

In order to reduce the torque ripple, it is preferred to skew the stator or the rotor of the motor 3 so as to take measures to convert the waveform of the induced voltage into the sinusoidal wave as much as possible. With the specifications including the waveform of the induced voltage close to the sinusoidal wave obtained by skewing, the torque ripple can be reduced to 5% or lower even only with the maximum-torque control in the case where the proportion of the reluctance torque to the total torque is smaller than 10%.

What is claimed is:

1. A brushless-motor control method for a brushless motor comprising:
a stator including an armature winding having a plurality of phases, which causes an induced voltage between lines to have a sinusoidal waveform; and
a rotor into which permanent magnets are embedded, the rotor being provided on an inner side of the stator so as to be rotatable,
the brushless motor rotating the rotor by a magnet torque generated due to a magnetic attraction force of the permanent magnets and a reluctance torque generated based on an inductance difference in a magnetic path,
the brushless-motor control method comprising:
calculating fundamental-wave currents indicating winding current values, which cause a maximum torque to be output in the brushless motor, in accordance with a load state of the brushless motor;
calculating a first harmonic component having an opposite phase with the same amplitude and the same period as an amplitude and a period of a torque ripple for the magnet torque based on a correction map indicating a relationship between phase currents of the armature winding and a parameter used to calculate the first harmonic component;
calculating a second harmonic component having an opposite phase with the same amplitude and the same period as an amplitude and a period of a torque ripple for the reluctance torque, which is generated in a state in which the first harmonic component is superimposed, based on the correction map indicating a relationship between the phase currents of the armature winding and a parameter used to calculate the second harmonic component; and
superimposing the first harmonic component and the second harmonic component respectively on the fundamental-wave currents to correct a current to be supplied to the armature winding.

2. A brushless-motor control method according to claim 1, wherein the correction map comprises:
a harmonic coefficient map indicating a relationship between the phase currents of the armature winding and the amplitude of the first harmonic component and a relationship between the phase currents of the armature winding and the amplitude of the second harmonic component; and
a phase-adjusting map indicating a relationship between the phase currents of the armature winding and a phase shift between a torque-ripple waveform and the first harmonic component, and a relationship between the phase currents of the armature winding and a phase shift between a torque-ripple waveform and the second harmonic component.

3. A brushless-motor control method according to claim 2, wherein:
the first harmonic component is expressed by B sin N(θ+β), where B is a harmonic amplitude coefficient, N is a positive integer, θ is a rotational angle in electric angle, and β is a phase shift, to be added to the fundamental-wave current Iqb in a q-axis direction;
the second harmonic component is expressed by A sin N(θ+α), where A is a harmonic amplitude coefficient, N is a positive integer, θ is a rotational angle in electric angle, and α is a phase shift, to be added to the fundamental-wave current Idb in a d-axis direction;
the harmonic coefficient map stores a relationship between the phase currents of the armature winding and the harmonic amplitude coefficient A and a relationship between the phase currents of the armature winding and the harmonic amplitude coefficient B; and
the phase-adjusting map stores a relationship between the phase currents of the armature winding and the phase shift α and a relationship between the phase currents of the armature winding and the phase shift β.

4. A brushless-motor control method according to claim 1, wherein the first harmonic component and the second harmonic component are respectively superimposed on the fundamental-wave currents in a high-load range in which a torque-ripple rate in the brushless motor exceeds 5%.

5. A brushless-motor control method according to claim 2, wherein the first harmonic component and the second harmonic component are respectively superimposed on the fundamental-wave currents in a high-load range in which a torque-ripple rate in the brushless motor exceeds 5%.

6. A brushless-motor control method according to claim 3, wherein the first harmonic component and the second harmonic component are respectively superimposed on the fundamental-wave currents in a high-load range in which a torque-ripple rate in the brushless motor exceeds 5%.

7. A brushless-motor control method according to claim 1, wherein the brushless motor is used as a driving source for an electric power steering apparatus.

8. A brushless-motor control method according to claim 2, wherein the brushless motor is used as a driving source for an electric power steering apparatus.

9. A brushless-motor control method according to claim 3, wherein the brushless motor is used as a driving source for an electric power steering apparatus.

10. A brushless-motor control method according to claim 4, wherein the brushless motor is used as a driving source for an electric power steering apparatus.

11. A brushless-motor control method according to claim 5, wherein the brushless motor is used as a driving source for an electric power steering apparatus.

12. A brushless-motor control method according to claim 6, wherein the brushless motor is used as a driving source for an electric power steering apparatus.

13. A brushless-motor control device for a brushless motor comprising:
a stator including an armature winding having a plurality of phases, which causes an induced voltage between lines to have a sinusoidal waveform; and
a rotor into which permanent magnets are embedded, the rotor being provided on an inner side of the stator so as to be rotatable,
the brushless motor rotating the rotor by a magnet torque generated due to a magnetic attraction force of the permanent magnets and a reluctance torque generated based on an inductance difference in a magnetic path,
the brushless-motor control device comprising:
a current sensor for detecting phase currents of the armature winding;
a fundamental-current calculating section for calculating fundamental-wave currents indicating winding current values, which cause a maximum torque to be output in the brushless motor, in accordance with a load state of the brushless motor;
a correction-component calculating section for calculating a first harmonic component having an opposite phase with the same amplitude and the same period as an amplitude and a period of a torque ripple for the magnet torque, and a second harmonic component having an opposite phase with the same amplitude and the same period as an amplitude and a period of a torque ripple for the reluctance torque, which is generated in a state in which the first harmonic component is superimposed, based on phase-current values detected by the current sensor;
a correction map indicating relationships between the phase currents and parameters used to calculate the first harmonic component and the second harmonic component; and
a current-correcting section for superimposing the first harmonic component and the second harmonic component, which are calculated by the correction-component calculating section, respectively on the fundamental-wave currents to correct a current to be supplied to the armature winding.

14. A brushless-motor control device according to claim 13, wherein the correction map comprises:
a harmonic coefficient map indicating a relationship between the phase currents of the armature winding and the amplitude of the first harmonic component and a relationship between the phase currents of the armature winding and the amplitude of the second harmonic component; and
a phase-adjusting map indicating a relationship between the phase currents of the armature winding and a phase shift between a torque-ripple waveform and the first harmonic component, and a relationship between the phase currents of the armature winding and a phase shift between a torque-ripple waveform and the second harmonic component.

15. A brushless-motor control device according to claim 13, wherein the brushless motor is used as a driving source for an electric power steering apparatus.

16. A brushless-motor control device according to claim 14, wherein the brushless motor is used as a driving source for an electric power steering apparatus.

17. An electric power steering apparatus, which uses, as a driving source, a brushless motor comprising:
a stator including an armature winding having a plurality of phases, which causes an induced voltage between lines to have a sinusoidal waveform; and
a rotor into which permanent magnets are embedded, the rotor being provided on an inner side of the stator so as to be rotatable,
the brushless motor rotating the rotor by a magnet torque generated due to a magnetic attraction force of the permanent magnets and a reluctance torque generated based on an inductance difference in a magnetic path,
the electric power steering apparatus being configured to:
calculate fundamental-wave currents indicating winding current values, which cause a maximum torque to be output in the brushless motor, in accordance with a load state of the brushless motor;
calculate a first harmonic component having an opposite phase with the same amplitude and the same period as an amplitude and a period of a torque ripple for the magnet torque based on a correction map indicating a relationship between phase currents of the armature winding and a parameter used to calculate the first harmonic component;
calculate a second harmonic component having an opposite phase with the same amplitude and the same period as an amplitude and a period of a torque ripple for the reluctance torque, which is generated in a state in which the first harmonic component is superimposed, based on the correction map indicating a relationship between the phase currents of the armature winding and a parameter used to calculate the second harmonic component; and
superimpose the first harmonic component and the second harmonic component respectively on the fundamental-wave currents to correct a current to be supplied to the armature winding.
